(19) United States
(12) Patent Application Publication
(10) Pub. No.: US 2023/0254856 A1
(43) Pub. Date: Aug. 10, 2023

(54) DEFAULT BEAM DETERMINATION FOR RECEPTION OF PDSCH TRANSMISSIONS WITH REPETITION

(71) Applicant: Lenovo (Beijing) Ltd., Beijing (CN)

(72) Inventors: Bingchao Liu, Changping District (CN); Chenxi Zhu, Haidian District (CN); Wei Ling, Changping (CN); Yi Zhang, Chao Yang District (CN)

(73) Assignee: Lenovo (Beijing) Ltd., Beijing (CN)

(21) Appl. No.: 17/924,839

(22) PCT Filed: May 15, 2020
(86) PCT No.: PCT/CN2020/090485

§ 371 Date: Nov. 11, 2022

(51) Int. Cl. H04W 72/1273; H04W 72/23

(52) U.S. Cl. CPC H04W 72/1273; H04W 72/23

(57) ABSTRACT

Methods and apparatuses for determining default beam(s) are disclosed. A method comprises receiving an activation command for the activated BWP of a serving cell, wherein the activation command contains codepoints pointing to TCI state (s) for PDSCH, and at least one codepoint points to two TCI states; and determining default TCI states for the reception of multiple PDSCH transmission occasions scheduled by a single DCI according to a scheduling offset between the reception of the DCI and the nth PDSCH transmission occasion, wherein n is larger than 1.

### FIELD

The subject matter disclosed herein generally relates to wireless communications, and more particularly relates to methods and apparatuses for determining default beams for reception of PDSCH transmissions with repetition transmitted from multiple TRPs.

### BACKGROUND

The following abbreviations are herewith defined, at least some of which are referred to within the following description: Third Generation Partnership Project (3GPP), European Telecommunications Standards Institute (ETSI), Frequency Division Duplex (FDD), Frequency Division Multiple Access (FDMA), Long Term Evolution (LTE), New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), Personal Digital Assistant (PDA), User Equipment (UE), Uplink (UL), Evolved Node B (eNB), Next Generation Node B (gNB), Downlink (DL), Central Processing Unit (CPU), Graphics Processing Unit (GPU), Field Programmable Gate Array (FPGA), Dynamic RAM (DRAM), Synchronous Dynamic RAM (SDRAM), Static RAM (SRAM), Liquid Crystal Display (LCD), Light Emitting Diode (LED), Organic LED (OLED), Orthogonal Frequency Division Multiplexing (OFDM), Radio Resource Control (RRC), Time-Division Duplex (TDD), Time Division Multiplex (TDM), User Entity/Equipment (Mobile Terminal) (UE), Uplink (UL), Universal Mobile Telecommunications System (UMTS), Physical Downlink Shared Channel (PDSCH), Physical Uplink Shared Channel (PUSCH), Physical Uplink Control Channel (PUCCH), Downlink control information (DCI), transmission reception point (TRP), multiple TRP (multi-TRP or M-TRP), Quasi Co-Location (QCL), channel state information reference signal (CSI-RS), Transmission Configuration Indication (TCI), reference signal (RS), component carrier (CC), band width part (BWP), Media Access Control (MAC), Control Element (CE), Demodulation Reference Signal (DM-RS), non-coherent joint transmission (NCJT), information element (IE).

Single-DCI based multi-TRP DL transmission mode is introduced in NR Release 16 for cell-edge UEs for high throughput and/or reliable transmission. For example, for a PDSCH transmission scheduled by a DCI transmitted from 2 TRPs, the TCI state(s) for reception of the PDSCH can be indicated by the ‘Transmission Configuration Indication’ field (i.e. TCI field) contained in the DCI. The TCI field is of 3 bits with eight possible values (also referred to as eight codepoints). Each codepoint may point to one or two TCI states. Especially, two TCI states can be pointed to by the TCI field in DCI format 1_1 and DCI format 1_2 for PDCSH reception in non-coherent joint transmission (NCJT) mode in which different PDSCH transmissions are transmitted from different TRPs. An activation command (e.g. TCI States Activation/Deactivation for UE-specific PDSCH MAC CE) is received at the UE to indicate the one or two TCI states pointed to by each of the eight codepoints for PDSCH.

The UE can be configured with a PDSCH-config IE by RRC signaling. The higher layer parameter PDSCH-TimeDomainResourceAllocation in PDSCH-config IE indicates that at least one entry in pdsch-TimeDomainAllocationList contains a higher layer parameter RepNumR16. The DCI scheduling multiple repeated PDSCH transmissions contains a ‘Time domain resource assignment’ field that indicates an entry of the pdsch-TimeDomainAllocationList in PDSCH-TimeDomainResourceAllocation containing the higher layer parameter RepNumR16. The value indicated by RepNumR16 in PDSCH-TimeDomainResourceAllocation indicates the repetition number of the scheduled PDSCH transmissions. For example, if the value indicated by RepNumR16 in ‘Time domain resource assignment’ field indicates that the repetition number is 4, the first PDSCH transmission occasion, the second PDSCH transmission occasion, the third PDSCH transmission occasion and the fourth PDSCH transmission occasion are scheduled. Hereinafter, the term “PDSCH transmission occasion” may be abbreviated as “PDSCH transmission” or simply “PDSCH”.

Two TCI states can be pointed to by the TCI field in DCI format 1_1 and/or DCI format 1_2 for PDCSH reception in NCJT mode. The first TCI state of the two TCI states pointed to by the codepoint indicated by the TCI field of the DCI is applied to the first PDSCH transmission occasion. When the value indicated by RepNumR16 in PDSCH-TimeDomainResourceAllocation is equal to two, the second TCI state of the two TCI states pointed to by the codepoint indicated by the TCI field of the DCI is applied to the second PDSCH transmission occasion.

When the value indicated by RepNumR16 in PDSCH-TimeDomainResourceAllocation is larger than two, the UE may be further configured to enable ‘CycMapping’ or ‘SeqMapping’ in RepTCIMapping for TCI mapping pattern for different PDSCH transmission occasions.

When CycMapping is enabled, the first and second TCI states are applied to the first and second PDSCH transmission occasions, respectively, and a TCI mapping pattern for CycMapping applies to the remaining PDSCH transmission occasions. The TCI mapping pattern for CycMapping means that the TCI states are repeatedly applied to every two PDSCH transmission occasions. That is, the first and second TCI states, which are respectively applied to the first and second PDSCH transmission occasions, are respectively applied to the third and the fourth PDSCH transmission occasions, the fifth and the sixth PDSCH transmission occasions, and etc, if these PDSCH transmission occasions are scheduled by the DCI. From another point of view, the first TCI state is applied to all of the odd-numbered PDSCH transmission occasions, e.g., the first (1^{st}) occasion, the third (3^{rd}) occasion, the fifth (5^{th}) occasion, etc, if scheduled; and the second TCI state is applied to all of the even-numbered PDSCH transmission occasions, e.g. the second (2^{nd}) occasion, the fourth (4^{th}) occasion, the sixth (6^{th}) occasion, etc, if scheduled.

When SeqMapping is enabled, the first TCI state is applied to the first and second PDSCH transmissions, and the second TCI state is applied to the third and fourth PDSCH transmissions, and a TCI mapping pattern for SeqMapping applies to the remaining PDSCH transmission occasions. The TCI mapping pattern for SeqMapping means that the TCI states are repeatedly applied to every four PDSCH transmission occasions. That is, the first TCI state, which is applied to the first and the second PDSCH transmission occasions, will be applied to the fifth and the sixth PDSCH transmission occasions, the ninth and the tenth PDSCH transmission occasions, etc, if scheduled. And the second TCI state, which is applied to the third and the fourth PDSCH transmission occasions, will be applied to the seventh and eighth PDSCH transmission occasions, the eleventh and the twelfth PDSCH transmission occasions, etc, if scheduled.

For example, suppose single-DCI based multi-TRP NCJT mode is configured for a UE on the serving cell, and the following TCI state activation MAC CE is received for the current active BWP of the serving cell.

{
TCI field with value of ‘000’ codepoint points to TCI state#0,
TCI field with value of ‘001’ codepoint points to TCI state#2,
TCI field with value of ‘010’ codepoint points to TCI state#5 and TCI state#8,
TCI field with value of ‘011’ codepoint points to TCI state#1 1,
TCI field with value of ‘100’ codepoint points to TCI state#38,
TCI field with value of ‘101’ codepoint points to TCI state#52 and TCI state#53,
TCI field with value of ‘110’ codepoint points to TCI state#65 and TCI state#88,
TCI field with value of ‘111’ codepoint points to TCI state#1 10
}

In the example provided in FIG. 1, a UE receive a DCI with TCI field =′101′ in slot m scheduling multiple PDSCH transmissions in slots n, n+1, n+2, and n+3 with RepNumR16=4. If the scheduling offset between the reception of the DL DCI and the first scheduled PDSCH, i.e. Slot offset 1, is equal to or greater than the threshold timeDurationForQCL, the UE will apply the indicated TCI states pointed to by the TCI field =`101′ contained in the DCI, i.e. TCI state#52 and TCI state#53, for reception of each PDSCH transmission occasion. As the value of RepNumR16, which is equal to 4, is larger than 2, a cyclical TCI state mapping scheme or a sequential TCI state mapping scheme may be configured.

For example, if the higher layer parameter RepTCIMapping is set as ‘CycMapping’ (i.e. cyclical TCI state mapping scheme is configured), the UE will apply TCI state#52 to the first PDSCH and the corresponding DM-RS reception and apply TCI state#53 to the second PDSCH and the corresponding DM-RS reception. The TCI mapping pattern for CycMapping applies to the remaining (i.e. the third and the fourth) PDSCH transmission occasions. In particular, TCI state#52 is applied to the third PDSCH transmission occasion; and TCI state#53 is applied to the fourth PDSCH transmission occasion.

As another example, if the higher layer parameter RepTCIMapping is set as ‘SeqMapping’ (i.e. sequential TCI state mapping scheme is configured), the UE will apply TCI state#52 to the first and the second PDSCH transmission occasions and the corresponding DM-RS reception and apply TCI state#53 to the third and the fourth PDSCH transmission occasions and the corresponding DM-RS reception.

However, when the scheduling offset between the reception of the DL DCI and the first scheduled PDSCH, i.e. Slot offset 1, is less than the threshold timeDurationForQCL, the UE will not have enough time to decode the DCI to obtain and change the TCI state for the reception of the scheduled PDSCH and adjust the beam to correspond to the obtained TCI state(s). In this condition, default TCI states have to be determined for the reception of each scheduled PDSCH.

This invention targets the default TCI state determination for multiple PDSCHs scheduled by a single DCI and transmitted from multiple TRPs.

### BRIEF SUMMARY

Methods and apparatuses for determining default beam(s) are disclosed.

In one embodiment, a method comprises receiving an activation command for the activated BWP of a serving cell, wherein the activation command contains codepoints pointing to TCI state(s) for PDSCH, and at least one codepoint points to two TCI states; and determining default TCI states for the reception of multiple PDSCH transmission occasions scheduled by a single DCI according to a scheduling offset between the reception of the DCI and the n^{th} PDSCH transmission occasion, wherein n is larger than 1.

The default TCI states are determined in different manners when CycMapping or SeqMapping is enabled.

In one embodiment, the value indicated by RepNumR16 in PDSCH-TimeDomainResourceAllocation is equal to or larger than two and CycMapping is enabled. In this condition, if the scheduling offset between the reception of the DCI and the first PDSCH occasion is less than a threshold timeDurationForQCL while the scheduling offset between the reception of the DCI and the second PDSCH occasion is equal to or greater than the threshold timeDurationForQCL, a first TCI state of the two different TCI states pointed to by the lowest codepoint among the codepoints pointing to two different TCI states is applied to the first PDSCH transmission occasion, and a second indicated TCI state by the TCI field in the scheduling DCI is applied to the second PDSCH transmission occasion. On the other hand, if the scheduling offset between the reception of the DCI and the second PDSCH occasion is less than a threshold timeDurationForQCL, a first TCI state of the two different TCI states pointed to by the lowest codepoint among the codepoints pointing to two different TCI states is applied to the first PDSCH transmission occasion, and a second TCI state of the two different TCI states pointed to by the lowest codepoint among the codepoints pointing to two different TCI states is applied to the second PDSCH transmission occasion. TCI mapping pattern for CycMapping applies to the remaining PDSCH transmission occasions.

In another embodiment, the value indicated by RepNumR16 in PDSCH-TimeDomainResourceAllocation is equal to or larger than three and SeqMapping is enabled. In this condition, if the scheduling offset between the reception of the DCI and the first PDSCH occasion is less than a threshold timeDurationForQCL, and the scheduling offset between the reception of the DCI and the third PDSCH occasion is equal to or greater than the threshold timeDurationForQCL, a first TCI state of the two different TCI states pointed to by the lowest codepoint among the codepoints pointing to two different TCI states is applied to the first and the second PDSCH transmission occasions, and a second indicated TCI state by the TCI field in the scheduling DCI is applied to the third and the fourth PDSCH transmission occasions. On the other hand, if the scheduling offset between the reception of the DCI and the third PDSCH occasion is less than a threshold timeDurationForQCL, a first TCI state of the two different TCI states pointed to by the lowest codepoint among the codepoints pointing to two different TCI states is applied to the first and the second PDSCH transmission occasions, and a second TCI state of the two different TCI states pointed to by the lowest codepoint among the codepoints pointing to two different TCI states is applied to the third and the fourth PDSCH transmission occasions. TCI mapping pattern for SeqMapping applies to the remaining PDSCH transmission occasions.

In another embodiment, a remote unit comprises a receiver that receives an activation command for the activated BWP of a serving cell, wherein the activation command contains codepoints pointing to TCI state(s) for PDSCH, and at least one codepoint points to two TCI states; and a processor that determines default TCI states for the reception of multiple PDSCH transmission occasions scheduled by a single DCI according to a scheduling offset between the reception of the DCI and the n^{th} PDSCH transmission occasion, wherein n is larger than 1.

In one embodiment, a method comprises transmitting an activation command for the activated BWP of a serving cell, wherein the activation command contains codepoints pointing to TCI state(s) for PDSCH, and at least one codepoint points to two TCI states; and determining default TCI states for the transmission of multiple PDSCHs scheduled by a single DCI according to a scheduling offset between the reception of the DCI and the n^{th} PDSCH transmission occasion, wherein n is larger than 1.

In yet another embodiment, a base unit comprises a transmitter that transmits an activation command for the activated BWP of a serving cell, wherein the activation command contains codepoints pointing to TCI state(s) for PDSCH, and at least one codepoint points to two TCI states; and a processor that determines default TCI states for the transmission of multiple PDSCHs scheduled by a single DCI according to a scheduling offset between the reception of the DCI and the n^{th} PDSCH transmission occasion, wherein n is larger than 1.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates an example of determining default TCI states according to prior art;

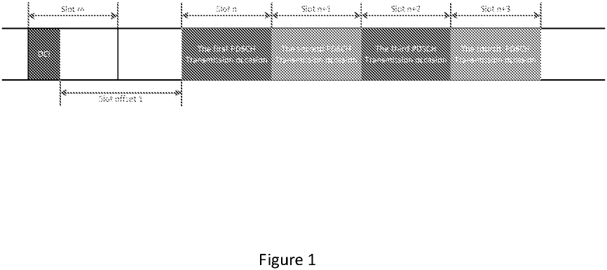

FIG. 2 illustrates an example of determining default TCI states according to the first and the second embodiments;

FIG. 3 illustrates an example of determining default TCI states according to the third and the fourth embodiments;

FIG. 4 is a schematic flow chart diagram illustrating an embodiment of a method;

FIG. 5 is a schematic flow chart diagram illustrating a further embodiment of a method; and

FIG. 6 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user’s computer, partly on the user’s computer, as a stand-alone software package, partly on the user’s computer and partly on a remote computer or entirely on the remote computer or server. In the very last scenario, the remote computer may be connected to the user’s computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

As described in the background part, a single DCI may schedule a number of repeated PDSCHs, wherein the number of PDSCHs is indicated by the value of RepNumR16 which is indicated by ‘Time domain resource assignment’ field contained in the DCI. The TCI field contained in the DCI contains a codepoint that points to one or two TCI states for the reception of the scheduled PDSCH(s). When the number of the scheduled PDSCHs are two or more, the codepoint contained in the TCI field would point to two TCI states. Depending on the configuration of the higher layer parameter RepTCIMapping (being set as CycMapping or SeqMapping), the TCI states pointed to by the codepoint contained in the TCI field would be used differently for the reception of the scheduled PDSCHs.

When the scheduling offset between the reception of the DCI scheduling PDSCHs and a first scheduled PDSCH is less than the threshold timeDurationForQCL, the UE will not have enough time to decode the DCI to obtain and change the TCI state(s) for the reception of at least the first scheduled PDSCH and adjust the beam to correspond to the obtained TCI state(s). In this condition, default TCI state(s) have to be determined.

A first embodiment relates to determining default TCI states when the higher layer parameter RepTCIMapping is set as CycMapping.

According to the first embodiment, a TCI state activation MAC CE for PDSCH is transmitted to the UE. The TCI state activation MAC CE contains for example eight (8) codepoints, each of which points to one or two TCI states. At least one codepoint points to two TCI states. In the first embodiment, a DCI schedules a number of repeated PDSCHs. The number of the scheduled PDSCHs is indicated by the value of RepNumR16 which is indicated by the ‘Time domain resource assignment’ field of the DCI.

The default TCI states for the reception of the scheduled PDSCHs according to the first embodiment are determined when the following three conditions are met:

(1) The value indicated by RepNumR16 is equal to or larger than two.

(2) CycMapping is enabled (i.e. the higher layer parameter RepTCIMapping is set as CycMapping).

(3) the scheduling offset between the reception of the scheduling DCI and the first scheduled PDSCH is less than the threshold timeDurationForQCL.

According to the first embodiment, all of scheduled PDSCHs are received with default TCI states for NCJT. In particular, the UE may assume that the DM-RS ports of the first scheduled PDSCH of a serving cell are quasi co-located (hereinafter, abbreviated as “QCLed”) with the RS(s) with respect to the QCL parameter(s) associated with the first TCI state of the two different TCI states pointed to by the lowest codepoint among the codepoints pointing to two different TCI states, and may assume that the DM-RS ports of the second scheduled PDSCH of a serving cell are QCLed with the RS(s) with respect to the QCL parameter(s) associated with the second TCI state of the two different TCI states pointed to by the lowest codepoint among the codepoints pointing to two different TCI states. The TCI mapping pattern for CycMapping applies to the remaining PDSCH transmission occasions. That is, the UE may assume that the DM-RS ports of all of odd-numbered scheduled PDSCHs of a serving cell are QCLed with the RS(s) with respect to the QCL parameter(s) associated with the first TCI state of the two different TCI states pointed to by the lowest codepoint among the codepoints pointing to two different TCI states, and may assume that the DM-RS ports of all of even-numbered scheduled PDSCHs of a serving cell are QCLed with the RS(s) with respect to the QCL parameter(s) associated with the second TCI state of the two different TCI states pointed to by the lowest codepoint among the codepoints pointing to two different TCI states.

The expression “are QCLed with the RS(s) with respect to the QCL parameter(s) associated with a TCI state” is further explained as follows:

The UE can be configured with a list of up to M TCI state configurations to decode PDSCH according to a detected PDCCH with DCI intended for the UE and the given serving cell, where M depends on the UE capability. The TCI state is configured by the following RRC signaling:
TCI state

The IE TCI state associates one or two DL reference signals with a corresponding quasicolocation (QCL) type.

TCI state information element

| | |
|---|---|
| -- ASN1START | |
| -- TAG-TCI STATE-START | |
| TCI state ::= | SEQUENCE { |
| TCI stateld | TCI stateId, |
| qcl-Type1 | QCL-Info, |
| qcl-Type2 | QCL-Info OPTIONAL, -- Need R |
| ... | |
| } | |
| QCL-Info ::= | SEQUENCE { |
| cell | ServCellIndex OPTIONAL, -- Need R |
| bwp-Id | BWP-Id OPTIONAL, -- Cond CSI-RS-Indicated |
| referenceSignal | CHOICE { |
| csi-rs | NZP-CSI-RS-ResourceId, |
| ssb | SSB-Index |
| }, | |
| qcl-Type | ENUMERATED (typeA, typeB, typeC, typeD), |
| ... | |
| ) | |
| -- TAG-TCI STATE-STOP | |
| -- ASN1STOP | |

Each TCI state contains parameters for configuring a quasi co-location (QCL) relationship between one or two downlink reference signals (i.e. RS(s)) and the DM-RS ports of the PDSCH, the DM-RS port of PDCCH or the CSI-RS port(s) of a CSI-RS resource. The quasi co-location relationship is configured by the higher layer parameter qcl-Typel for the first downlink RS, and qcl-Type2 for the second downlink RS (if configured). For the case of two downlink RSs, the QCL types shall not be the same, regardless of whether the references are to the same downlink RS or different downlink RSs. The quasi co-location types (i.e. QCL parameter(s)) corresponding to each downlink RS are given by the higher layer parameter qcl-Type in QCL-Info and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

For example, if a TCI state is configured as TCI state = {CSI-RS#1, QCL-TypeA; CSI-RS#2, QCL-TypeD} and it is indicated for a PDSCH reception, it means that the UE may assume that the Doppler shift, Doppler spread, average delay, delay spread for the DM-RS ports of the PDSCH are the same as those estimated by CSI-RS#1 and the UE may receive the PDSCH and the corresponding DM-RS port using the same spatial RX parameter as that used to receive CSI-RS#2. We can say that “the UE may assume that the DM-RS ports of the scheduled PDSCH are quasi co-located (i.e. QCLed) with CSI-RS#1 with respect to ‘QCL-TypeA’, and quasi co-located with CSI-RS#2 with respect to ‘QCL-TypeD’ (or abbreviated as “QCLed with the RS(s) with respect to the QCL parameter(s) associated with the indicated TCI state”). In other words, the QCL assumption of the DM-RS ports of the scheduled PDSCH (for the reception of the PDSCH) is determined according to the indicated TCI state.

In the following description, the expression such as “the UE may assume that the DM-RS ports of a PDSCH of a serving cell are QCLed with the RS(s) with respect to the QCL parameter(s) associated with a TCI state” may be simply expressed as “the UE applies a TCI state to a PDSCH” or “a TCI state is applied to a PDSCH”.

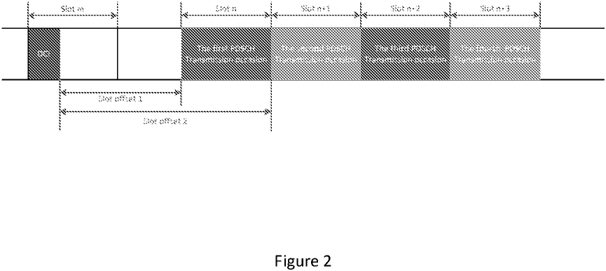

FIG. 2 illustrates an example of the first embodiment. Suppose single-DCI based multi-TRP non-coherent joint transmission (NCJT) mode is configured for a UE on the serving cell, and the following TCI state activation MAC CE is received for the current active BWP of the serving cell.

{
TCI field with value of ‘000’ codepoint points to TCI state#0,
TCI field with value of ‘001’ codepoint points to TCI state#2,
TCI field with value of ‘010’ codepoint points to TCI state#5 and TCI state#8,
TCI field with value of ‘011’ codepoint points to TCI state#11,
TCI field with value of ‘100’ codepoint points to TCI state#38,
TCI field with value of ‘101’ codepoint points to TCI state#52 and TCI state#53,
TCI field with value of ‘110’ codepoint points to TCI state#65 and TCI state#88,
TCI field with value of ‘111’ codepoint points to TCI state#1 10
}

As shown in FIG. 2, the UE receives the scheduling DCI with TCI field ‘101’ in slot m scheduling four PDSCH transmissions in slots n, n+1, n+2, and n+3 with RepNumR16=4. If the scheduling offset between the reception of the scheduling DCI and the first scheduled PDSCH, i.e. Slot offset 1, is less than the threshold timeDurationForQCL, the UE will apply TCI State#5 and TCI State#8, that are the two TCI states pointed to by the lowest codepoint ‘010’ among the codepoints pointing to two different TCI states, for reception of each PDSCH transmission occasion. When the cyclical TCI state mapping scheme is configured, i.e. the higher layer parameter RepTCIMapping is set as ‘CycMapping’, the UE applies TCI state#5 to the first and the third scheduled PDSCHs and the corresponding DM-RS reception, and applies TCI state#8 for the second and the fourth scheduled PDSCHs and the corresponding DM-RS reception.

According to the first embodiment, the UE ignores all the indicated TCI states (e.g. TCI state#52 and TCI state#53 pointed to by the TCI field ‘101’ contained in the DCI) when the scheduling offset between the reception of the scheduling DCI and the first scheduled PDSCH is less than the threshold timeDurationForQCL. However, if the scheduling offset between the reception of the scheduling DCI and the second scheduled PDSCH, i.e. Slot offset 2 in FIG. 2, is equal to or greater than the threshold timeDurationForQCL in this scenario, the indicated TCI state may be used for the reception of the scheduled PDSCHs starting from the second scheduled PDSCH (e.g. the second, the third and the fourth PDSCHs) for performance gain. So, a second embodiment is proposed.

According to the second embodiment, the default TCI states for the reception of the scheduled PDSCHs are determined when the following three conditions are met:

(1) the value indicated by RepNumR16 is equal to or larger than two.

(2) CycMapping is enabled (i.e. the higher layer parameter RepTCIMapping is set as CycMapping).

(3) the scheduling offset between the reception of the scheduling DCI and the first scheduled PDSCH is less than the threshold timeDurationForQCL, while the scheduling offset between the reception of the scheduling DCI and the second scheduled PDSCH is equal to or greater than the threshold timeDurationForQCL.

According to the second embodiment, the first TCI state of the two different TCI states pointed to by the lowest codepoint among the codepoints pointing to two different TCI states is applied to the first scheduled PDSCH, and the second indicated TCI state by the TCI field in the scheduling DCI is applied to the second scheduled PDSCH. The TCI mapping pattern for CycMapping applies to the remaining PDSCH transmission occasions. That is, the first TCI state of the two different TCI states pointed to by the lowest codepoint among the codepoints pointing to two different TCI states is applied to all of odd-numbered scheduled PDSCH(s), and the second indicated TCI state by the TCI field in the scheduling DCI is applied to all of even-numbered scheduled PDSCH(s).

It can be seen that, as the scheduling offset between the reception of the scheduling DCI and the second scheduled PDSCH is equal to or greater than the threshold timeDurationForQCL, the UE has enough time to decode the DCI to obtain and change the TCI state for the reception of the second scheduled PDSCH (and the following scheduled PDSCHs after the second scheduled PDSCH) and adjust the beam to correspond to the obtained TCI state(s). Therefore, according to the second embodiment, the second indicated TCI state by the TCI field in the scheduling DCI is applied to the second scheduled PDSCH, and is applied to all of following even-numbered scheduled PDSCH(s).

On the other hand, although the indicated TCI states (e.g. the first indicated TCI state) by the TCI field in the scheduling DCI can be possibly applied to the third scheduled PDSCH (and the following odd-numbered scheduled PDSCHs), according to the second embodiment, the first TCI state of the two different TCI states pointed to by the lowest codepoint among the codepoints pointing to two different TCI states is applied to the third scheduled PDSCH (and the following odd-numbered scheduled PDSCHs). This is in consideration of the TCI mapping pattern for CycMapping (i.e. the same TCI state as the TCI state for reception of the first scheduled PDSCH applies to all of the odd-numbered scheduled PDSCHs).

A variety of the second embodiment is described as follows. If the scheduling offset between the reception of the scheduling DCI and the second scheduled PDSCH is less than the threshold timeDurationForQCL, the same default TCI state determination as the first embodiment is adopted. That is, the first TCI state and the second TCI state of the two different TCI states pointed to by the lowest codepoint among the codepoints pointing to two different TCI states are applied to the first scheduled PDSCH and the second scheduled PDSCH, respectively. In addition, the TCI mapping pattern for CycMapping applies to the remaining PDSCH transmission occasions. That is, the first TCI state of the two different TCI states pointed to by the lowest codepoint among the codepoints pointing to two different TCI states is applied to all of odd-numbered scheduled PDSCH(s), and the second TCI state of the two different TCI states pointed to by the lowest codepoint among the codepoints pointing to two different TCI states is applied to all of even-numbered scheduled PDSCH(s).

An example of the second embodiment is described with reference to FIG. 2. Suppose single-DCI based multi-TRP non-coherent joint transmission (NCJT) mode is configured for a UE on the serving cell, and the following TCI state activation MAC CE is received for the current active BWP of the serving cell.

{
TCI field with value of ‘000’ codepoint points to TCI state#0,
TCI field with value of ‘001’ codepoint points to TCI state#2,
TCI field with value of ‘010’ codepoint points to TCI state#5 and TCI state#8,
TCI field with value of ‘011’ codepoint points to TCI state#11,
TCI field with value of ‘100’ codepoint points to TCI state#38,
TCI field with value of ‘101’ codepoint points to TCI state#52 and TCI state#53,
TCI field with value of ‘110’ codepoint points to TCI state#65 and TCI state#88,
TCI field with value of ‘111’ codepoint points to TCI state#1 10
}

As shown in FIG. 2, the UE receives the scheduling DCI with TCI field =‘101’ in slot m scheduling four PDSCH transmissions in slots n, n+1, n+2, and n+3 with RepNumR16=4. According to the second embodiment, if the scheduling offset between the reception of the scheduling DCI and the first scheduled PDSCH, i.e. Slot offset 1, is less than the threshold timeDurationForQCL while the scheduling offset between the reception of the scheduling DCI and the second scheduled PDSCH, i.e. Slot offset 2, is equal to or greater than the threshold timeDurationForQCL, the UE will apply TCI State#5, which is the first TCI state pointed to by the lowest codepoint ‘010’ among the codepoints pointing to two different TCI states, to the first and the third scheduled PDSCHs, and apply TCI State#53, which is the second indicated state by the TCI field in the scheduling DCI, to the second and the fourth scheduled PDSCHs.

On the other hand, according to the variety of the second embodiment, if the scheduling offset between the reception of the scheduling DCI and the second scheduled PDSCH, i.e. Slot offset 2, is less than the threshold timeDurationForQCL, the UE will apply TCI State#5, which is the first TCI state pointed to by the lowest codepoint ‘010’ among the codepoints pointing to two different TCI states, to the first and the third scheduled PDSCHs, and apply TCI State#8, which is the second TCI state pointed to by the lowest codepoint ‘010’ among the codepoints pointing to two different TCI states, to the second and the fourth scheduled PDSCHs.

The first and the second embodiments are related to determining default TCI states when the higher layer parameter RepTCIMapping is set as CycMapping. The following third and fourth embodiments are related to determining default TCI states when the higher layer parameter RepTCIMapping is set as SeqMapping.

According to the third embodiment, a TCI state activation MAC CE for PDSCH is transmitted to the UE. The TCI state activation MAC CE contains for example eight (8) codepoints, each of which points to one or two TCI states. At least one codepoint points to two TCI states. In the third embodiment, a DCI schedules a number of repeated PDSCHs. The number of the scheduled PDSCHs is indicated by the value of RepNumR16 which is indicated by the ‘Time domain resource assignment’ field of the DCI.

The default TCI states for the reception of the scheduled PDSCHs according to the third embodiment are determined when the following three conditions are met:

(1) the value indicated by RepNumR16 is equal to or larger than three.

(2) SeqMapping is enabled (i.e. the higher layer parameter RepTCIMapping is set as SeqMapping).

(3) the scheduling offset between the reception of the scheduling DCI and the first scheduled PDSCH is less than the threshold timeDurationForQCL.

According to the third embodiment, all of scheduled PDSCHs are received with default TCI states for NCJT. In particular, the UE may assume that the DM-RS ports of the first and the second scheduled PDSCHs of a serving cell are QCLed with the RS(s) with respect to the QCL parameter(s) associated with the first TCI state of the two different TCI states pointed to by the lowest codepoint among the codepoints pointing to two different TCI states, and may assume that the DM-RS ports of the third and the fourth scheduled PDSCHs of a serving cell are QCLed with the RS(s) with respect to the QCL parameter(s) associated with the second TCI state of the two different TCI states pointed to by the lowest codepoint among the codepoints pointing to two different TCI states. The TCI mapping pattern for SeqMapping applies to the remaining PDSCH transmission occasions. That is, the UE may apply the same TCI states applied to the first to the fourth scheduled PDSCHs, to the fifth to the eighth scheduled PDSCHs, the ninth to the twelfth scheduled PDSCHs, etc.

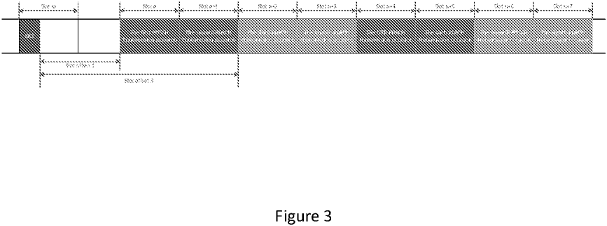

FIG. 3 illustrates an example of the third embodiment. Suppose single-DCI based multi-TRP non-coherent joint transmission (NCJT) mode is configured for a UE on the serving cell, and the following TCI state activation MAC CE is received for the current active BWP of the serving cell.

{
TCI field with value of `000′ codepoint points to TCI state#0,
TCI field with value of `001′ codepoint points to TCI state#2,
TCI field with value of ‘010’ codepoint points to TCI state#5 and TCI state#8,
TCI field with value of ‘011’ codepoint points to TCI state#11,
TCI field with value of `100′ codepoint points to TCI state#38,
TCI field with value of ‘101’ codepoint points to TCI state#52 and TCI state#53,
TCI field with value of `110′ codepoint points to TCI state#65 and TCI state#88,
TCI field with value of `111′ codepoint points to TCI state#1 10
}

As shown in FIG. 3, the UE receives the scheduling DCI with TCI field =‘101’ in slot m scheduling eight PDSCH transmissions in slots n, n+1, n+2, n+3, n+4, n+5, n+6, and n+7 with RepNumR16=8. If the scheduling offset between the reception of the scheduling DCI and the first scheduled PDSCH, i.e. Slot offset 1, is less than the threshold timeDurationForQCL, the UE will apply TCI State#5 and TCI State#8, that are the two TCI states pointed to by the lowest codepoint ‘010’ among the codepoints pointing to two different TCI states, for reception of each PDSCH transmission occasion. When the sequential TCI state mapping scheme is configured, i.e. the higher layer parameter RepTCIMapping is set as ‘SeqMapping, the UE applies TCI state#5 to the first, the second, the fifth and the sixth scheduled PDSCHs and the corresponding DM-RS reception, and applies TCI state#8 to the third, the fourth, the seventh and the eighth scheduled PDSCHs and the corresponding DM-RS reception.

According to the third embodiment, the UE ignores all the indicated TCI states (e.g. TCI state#52 and TCI state#53 pointed to by the TCI field ‘101’ contained in the DCI) when the scheduling offset between the reception of the scheduling DCI and the first scheduled PDSCH is less than the threshold timeDurationForQCL. However, if the scheduling offset between the reception of the scheduling DCI and the third scheduled PDSCH, i.e. Slot offset 3 in FIG. 3, is equal to or greater than the threshold timeDurationForQCL in this scenario, the indicated TCI state may be used for the reception of the scheduled PDSCHs starting from the third scheduled PDSCH (e.g. the third, the fourth, the fifth, the sixth, the seventh and the eighth scheduled PDSCHs) for performance gain. So, the fourth embodiment is proposed.

According to the fourth embodiment, the default TCI states for the reception of the scheduled PDSCHs are determined when the following three conditions are met:

(1) the value indicated by RepNumR16 is equal to or larger than three.

(2) SeqMapping is enabled (i.e. the higher layer parameter RepTCIMapping is set as SeqMapping).

(3) the scheduling offset between the reception of the scheduling DCI and the first scheduled PDSCH is less than the threshold timeDurationForQCL, while the scheduling offset between the reception of the scheduling DCI and the third scheduled PDSCH is equal to or greater than the threshold timeDurationForQCL.

According to the fourth embodiment, the first TCI state of the two different TCI states pointed to by the lowest codepoint among the codepoints pointing to two different TCI states is applied to the first and the second scheduled PDSCHs, and the second indicated TCI state by the TCI field in the scheduling DCI is applied to the third and the fourth scheduled PDSCHs. The TCI mapping pattern for SeqMapping applies to the remaining PDSCH transmission occasions. That is, the UE may apply the same TCI states applied to the first to the fourth scheduled PDSCHs, to the fifth to the eighth scheduled PDSCHs, the ninth to the twelfth scheduled PDSCHs, etc. From another point of view, the first TCI state of the two different TCI states pointed to by the lowest codepoint among the codepoints pointing to two different TCI states, which is applied to the first and the second scheduled PDSCHs, is applied to the fifth and the sixth scheduled PDSCHs, the ninth and the tenth scheduled PDSCHs, and etc. And the second indicated TCI state by the TCI field in the scheduling DCI, which is applied to the third and the fourth scheduled PDSCHs, is applied to the seventh and the eighth scheduled PDSCHs, the eleventh and the twelfth scheduled PDSCHs, and etc.

It can be seen that, as the scheduling offset between the reception of the scheduling DCI and the third scheduled PDSCH is equal to or greater than the threshold timeDurationForQCL, the UE has enough time to decode the DCI to obtain and change the TCI state for the reception of the third scheduled PDSCH (and the following scheduled PDSCHs after the third scheduled PDSCH) and adjust the beam to correspond to the obtained TCI state(s). Therefore, according to the fourth embodiment, the second indicated TCI state by the TCI field in the scheduling DCI can be applied to the third and the fourth scheduled PDSCHs, and to the seventh and eighth scheduled PDSCHs and etc.

Different from the second embodiment in which the scheduling offset between the reception of the scheduling DCI and the second scheduled PDSCH is further compared with the threshold timeDurationForQCL, in the fourth embodiment, the scheduling offset between the reception of the scheduling DCI and the third scheduled PDSCH is further compared with the threshold timeDurationForQCL. This is because, according to the TCI mapping pattern for SeqMapping, the same TCI state as the first scheduled PDSCH is applied to the second scheduled PDSCH.

In addition, although the indicated TCI states (e.g. the first indicated TCI state) by the TCI field in the scheduling DCI can be possibly applied to the fifth and the sixth scheduled PDSCHs, the first TCI state of the two different TCI states pointed to by the lowest codepoint among the codepoints pointing to two different TCI states is applied to the fifth and the sixth scheduled PDSCHs according to the fourth embodiment in view of the TCI mapping pattern for SeqMapping.

A variety of the fourth embodiment is described as follows. If the scheduling offset between the reception of the scheduling DCI and the third scheduled PDSCH is less than the threshold timeDurationForQCL, the same default TCI state determination as the third embodiment is adopted. That is, the first TCI state of the two different TCI states pointed to by the lowest codepoint among the codepoints pointing to two different TCI states is applied to the first and the second scheduled PDSCHs, and the second TCI state of the two different TCI states pointed to by the lowest codepoint among the codepoints pointing to two different TCI states is applied to the third and the fourth scheduled PDSCHs. In addition, the TCI mapping pattern for SeqMapping applies to the remaining PDSCH transmission occasions.

An example of the fourth embodiment is described with reference to FIG. 3. Suppose single-DCI based multi-TRP non-coherent joint transmission (NCJT) mode is configured for a UE on the serving cell, and the following TCI state activation MAC CE is received for the current active BWP of the serving cell.

{
TCI field with value of `000′ codepoint points to TCI state#0,
TCI field with value of `001′ codepoint points to TCI state#2,
TCI field with value of ‘010’ codepoint points to TCI state#5 and TCI state#8,
TCI field with value of ‘011’ codepoint points to TCI state#11,
TCI field with value of `100′ codepoint points to TCI state#38,
TCI field with value of ‘101’ codepoint points to TCI state#52 and TCI state#53,
TCI field with value of `110′ codepoint points to TCI state#65 and TCI state#88,
TCI field with value of `111′ codepoint points to TCI state#1 10
}

As shown in FIG. 3, the UE receives the scheduling DCI with TCI field =‘101’ in slot m scheduling eight PDSCH transmissions in slots n, n+1, n+2, n+3, n+4, n+5, n+6, and n+7 with RepNumR16=8. If the scheduling offset between the reception of the scheduling DCI and the first scheduled PDSCH, i.e. Slot offset 1, is less than the threshold timeDurationForQCL, while the scheduling offset between the reception of the scheduling DCI and the third scheduled PDSCH, i.e. Slot offset 3, is equal to or greater than the threshold timeDurationForQCL, the UE will apply TCI State#5 that is the first TCI state pointed to by the lowest codepoint ‘010’ among the codepoints pointing to two different TCI states to the first, the second, the fifth and the sixth scheduled PDSCHs, and apply TCI State#53 that is the second indicated state by the TCI field in the scheduling DCI to the third, the fourth, the seventh and the eighth scheduled PDSCHs.

On the other hand, according to the variety of the fourth embodiment, if the scheduling offset between the reception of the scheduling DCI and the third scheduled PDSCH, i.e. Slot offset 3, is less than the threshold timeDurationForQCL, the UE will apply TCI State#5 that is the first TCI state pointed to by the lowest codepoint ‘010’ among the codepoints pointing to two different TCI states to the first, the second, the fifth and the sixth scheduled PDSCHs, and apply TCI State#8 that is the second TCI state pointed to by the lowest codepoint ‘010’ among the codepoints pointing to two different TCI states to the third, the fourth, the seventh and the eighth scheduled PDSCHs.

In all of the above embodiments, the invention is described from the point of view of UE. That is, the DCI scheduling PDSCHs is received at the UE; and the scheduled PDSCHs are received at the UE. On the other hand, from the point of view of gNB (base station), the DCI scheduling PDSCHs is transmitted from the gNB; and the scheduled PDSCHs are transmitted from the gNB.

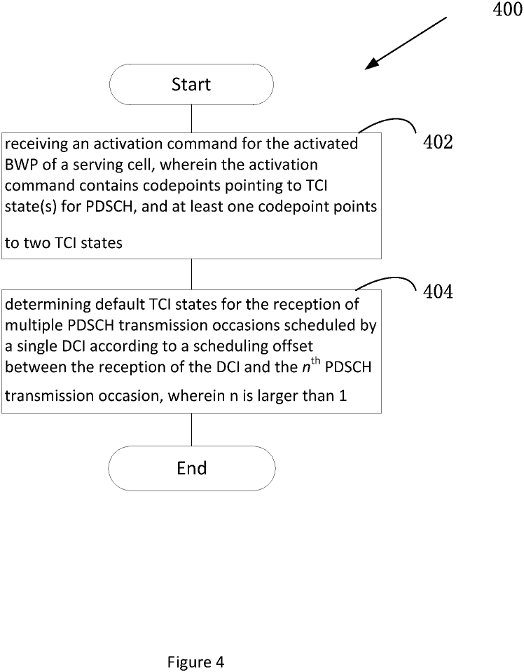

FIG. 4 is a schematic flow chart diagram illustrating an embodiment of a method 400 according to the present application. In some embodiments, the method 400 is performed by an apparatus, such as a remote unit. In certain embodiments, the method 400 may be performed by a processor executing program code, for example, a microcontroller, a microprocessor, a CPU, a GPU, an auxiliary processing unit, a FPGA, or the like.

The method 400 may include 402 receiving an activation command for the activated BWP of a serving cell, wherein the activation command contains codepoints pointing to TCI state(s) for PDSCH, and at least one codepoint points to two TCI states and 404 determining default TCI states for the reception of multiple PDSCH transmission occasions scheduled by a single DCI according to a scheduling offset between the reception of the DCI and the n^{th} PDSCH transmission occasion, wherein n is larger than 1.

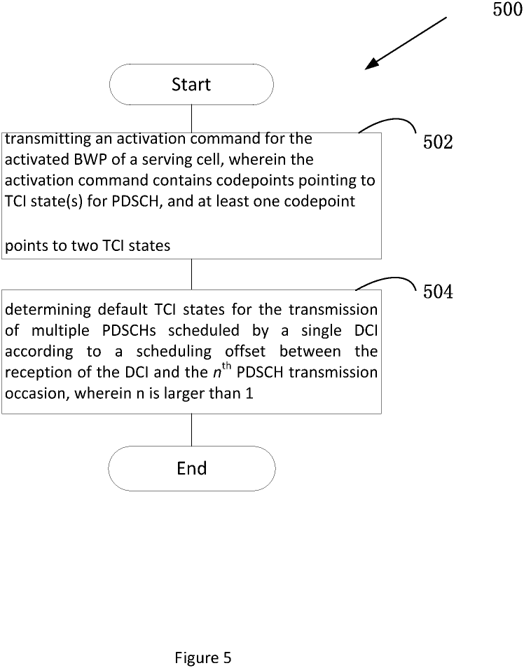

FIG. 5 is a schematic flow chart diagram illustrating an embodiment of a method 500 according to the present application. In some embodiments, the method 500 is performed by an apparatus, such as a base unit. In certain embodiments, the method 500 may be performed by a processor executing program code, for example, a microcontroller, a microprocessor, a CPU, a GPU, an auxiliary processing unit, a FPGA, or the like.

The method 500 may include 502 transmitting an activation command for the activated BWP of a serving cell, wherein the activation command contains codepoints pointing to TCI state(s) for PDSCH, and at least one codepoint points to two TCI states and 504 determining default TCI states for the transmission of multiple PDSCHs scheduled by a single DCI according to a scheduling offset between the reception of the DCI and the n^{th} PDSCH transmission occasion, wherein n is larger than 1.

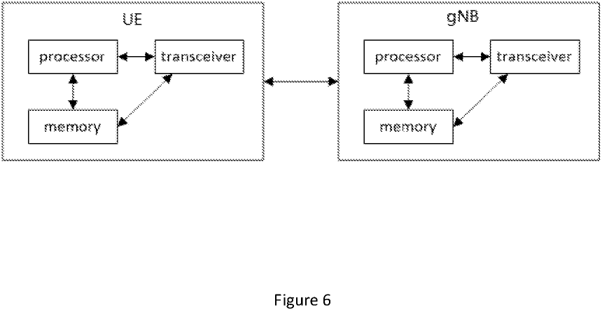

FIG. 6 is a schematic block diagram illustrating apparatuses according to one embodiment.

Referring to FIG. 6, the UE (i.e. the remote unit) includes a processor, a memory, and a transceiver. The processor implements a function, a process, and/or a method which are proposed in FIG. 4. The gNB (i.e. base unit) includes a processor, a memory, and a transceiver. The processors implement a function, a process, and/or a method which are proposed in FIG. 5. Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A method comprising:
receiving an activation command for an activated band width part of a serving cell, wherein the activation command contains codepoints pointing to one or more Transmission Configuration Indication (TCI) states for Physical Downlink Shared Channel (PDSCH), and at least one codepoint points to two TCI states; and
determining default TCI states for reception of multiple PDSCH transmission occasions scheduled by a single DCI according to a scheduling offset between reception of Downlink control information (DCI) and an n^{th} PDSCH transmission occasion, wherein n is larger than 1.

2. The method of claim 1, wherein, when a value indicated by RepNumR16 in PDSCH-TimeDomainResourceAllocation is equal to or larger than two and CycMapping is enabled, if the scheduling offset between the reception of the DCI and a first PDSCH transmission occasion is less than a threshold timeDurationForQCL while the scheduling offset between the reception of the DCI and a second PDSCH transmission occasion is equal to or greater than the threshold timeDurationForQCL, a first TCI state of the two TCI states pointed to by a lowest codepoint among the at least one codepoint pointing to two TCI states is applied to the first PDSCH transmission occasion, and a second indicated TCI state by a TCI field in the DCI is applied to the second PDSCH transmission occasion, and a TCI mapping pattern for CycMapping applies to remaining PDSCH transmission occasions.

3. The method of claim 1, wherein, when a value indicated by RepNumR16 in PDSCH-TimeDomainResourceAllocation is equal to or larger than two and CycMapping is enabled, if the scheduling offset between the reception of the DCI and a second PDSCH occasion is less than a threshold timeDurationForQCL, a first TCI state of the two TCI states pointed to by a lowest codepoint among the at least one codepoint pointing to two TCI states is applied to a first PDSCH transmission occasion, and a second TCI state of the two TCI states pointed to by the lowest codepoint among the at least one codepoint pointing to two TCI states is applied to the second PDSCH transmission occasion, and a TCI mapping pattern for CycMapping applies to remaining PDSCH transmission occasions.

4. The method of claim 1, wherein, when a value indicated by RepNumR16 in PDSCH-TimeDomainResourceAllocation is equal to or larger than three and SeqMapping is enabled, if the scheduling offset between the reception of the DCI and a first PDSCH occasion is less than a threshold timeDurationForQCL, and the scheduling offset between the reception of the DCI and a third PDSCH occasion is equal to or greater than the threshold timeDurationForQCL, a first TCI state of the two TCI states pointed to by a lowest codepoint among the at least one codepoint pointing to two TCI states is applied to the first and a second PDSCH transmission occasions, and a second indicated TCI state by a TCI field in the DCI is applied to the third and a fourth PDSCH transmission occasions, and a TCI mapping pattern for SeqMapping applies to remaining PDSCH transmission occasions.

5. The method of claim 1, wherein, when a value indicated by RepNumR16 in PDSCH-TimeDomainResourceAllocation is equal to or larger than three and SeqMapping is enabled, if the scheduling offset between the reception of the DCI and a third PDSCH occasion is less than a threshold timeDurationForQCL, a first TCI state of the two TCI states pointed to by a lowest codepoint among the at least one codepoint pointing to two TCI states is applied to the first and a second PDSCH transmission occasions, and a second TCI state of the two TCI states pointed to by the lowest codepoint among the at least one codepoint pointing to two TCI states is applied to the third and a fourth PDSCH transmission occasions, and a TCI mapping pattern for SeqMapping applies to remaining PDSCH transmission occasions.

6. A remote unit, comprising:
a receiver; and
a processor coupled to the receiver configured to cause the remote unit to:
receive an activation command for an activated band width part of a serving cell, wherein the activation command contains codepoints pointing to one or more Transmission Configuration Indication (TCI) states for Physical Downlink Shared Channel (PDSCH), and at least one codepoint points to two TCI states; and
determine a default TCI states for reception of multiple PDSCH transmission occasions scheduled by a single DCI according to a scheduling offset between reception of Downlink control information (DCI) and an n^{th} PDSCH transmission occasion, wherein n is larger than 1.

7. The remote unit of claim 6, wherein, when a value indicated by RepNumR16 in PDSCH-TimeDomainResourceAllocation is equal to or larger than two and CycMapping is enabled, if the scheduling offset between the reception of the DCI and a first PDSCH transmission occasion is less than a threshold timeDurationForQCL while the scheduling offset between the reception of the DCI and a second PDSCH transmission occasion is equal to or greater than the threshold timeDurationForQCL, a first TCI state of the two TCI states pointed to by a lowest codepoint among the at least one codepoint pointing to two TCI states is applied to the first PDSCH transmission occasion, and a second indicated TCI state by a TCI field in the DCI is applied to the second PDSCH transmission occasion, and a TCI mapping pattern for CycMapping applies to remaining PDSCH transmission occasions.

8. The remote unit of claim 6, wherein, when a value indicated by RepNumR16 in PDSCH-TimeDomainResourceAllocation is equal to or larger than two and CycMapping is enabled, if the scheduling offset between the reception of the DCI and a second PDSCH occasion is less than a threshold timeDurationForQCL, a first TCI state of the two TCI states pointed to by a lowest codepoint among the at least one codepoint pointing to two TCI states is applied to a first PDSCH transmission occasion, and a second TCI state of the two TCI states pointed to by the lowest codepoint among the at least one codepoint pointing to two TCI states is applied to the second PDSCH transmission occasion, and a TCI mapping pattern for CycMapping applies to remaining PDSCH transmission occasions.

9. The remote unit of claim 6, wherein, when a value indicated by RepNumR16 in PDSCH-TimeDomainResourceAllocation is equal to or larger than three and SeqMapping is enabled, if the scheduling offset between the reception of the DCI and a first PDSCH occasion is less than a threshold timeDurationForQCL, and the scheduling offset between the reception of the DCI and a third PDSCH occasion is equal to or greater than the threshold timeDurationForQCL, a first TCI state of the two TCI states pointed to by a lowest codepoint among the at least one codepoint pointing to two different TCI states is applied to the first and a second PDSCH transmission occasions, and a second indicated TCI state by a TCI field in the DCI is applied to the third and a fourth PDSCH transmission occasions, and a TCI mapping pattern for SeqMapping applies to remaining PDSCH transmission occasions.

10. The remote unit of claim 6, wherein, when a value indicated by RepNumR16 in PDSCH-TimeDomainResourceAllocation is equal to or larger than three and SeqMapping is enabled, if the scheduling offset between the reception of the DCI and a third PDSCH occasion is less than a threshold timeDurationForQCL, a first TCI state of the two TCI states pointed to by a lowest codepoint among the at least one codepoint pointing to two TCI states is applied to the first and a second PDSCH transmission occasions, and a second TCI state of the two TCI states pointed to by the lowest codepoint among the at least one codepoint pointing to two TCI states is applied to the third and a fourth PDSCH transmission occasions, and a TCI mapping pattern for SeqMapping applies to remaining PDSCH transmission occasions.

11. (canceled)

12. (canceled)

13. (canceled)

14. (canceled)

15. (canceled)

16. A base unit, comprising:
a transmitter; and
a processor coupled to the transmitter configured to cause the base unit to:
transmit an activation command for an activated band width part of a serving cell, wherein the activation command contains codepoints pointing to one or more Transmission Configuration Indication (TCI) states for Physical Downlink Shared Channel (PDSCH), and at least one codepoint points to two TCI states; and
determine a default TCI states for transmission of multiple PDSCHs scheduled by a single Downlink control information (DCI) according to a scheduling offset between reception of the DCI and an n^{th} PDSCH transmission occasion, wherein n is larger than 1.

17. The base unit of claim 16, wherein, when a value indicated by RepNumR16 in PDSCH-TimeDomainResourceAllocation is equal to or larger than two and CycMapping is enabled, if the scheduling offset between the reception of the DCI and a first PDSCH transmission occasion is less than a threshold timeDurationForQCL while the scheduling offset between the reception of the DCI and a second PDSCH transmission occasion is equal to or greater than the threshold timeDurationForQCL, a first TCI state of the two TCI states pointed to by a the lowest codepoint among the at least one codepoint pointing to two TCI states is applied to the first PDSCH transmission occasion, and a second indicated TCI state by a TCI field in the DCI is applied to the second PDSCH transmission occasion, and a TCI mapping pattern for CycMapping applies to remaining PDSCH transmission occasions.

18. The base unit of claim 16, wherein, when a value indicated by RepNumR16 in PDSCH-TimeDomainResourceAllocation is equal to or larger than two and CycMapping is enabled, if the scheduling offset between the reception of the DCI and a second PDSCH occasion is less than a threshold timeDurationForQCL, a first TCI state of the two TCI states pointed to by a lowest codepoint among the at least one codepoint pointing to two TCI states is applied to a first PDSCH transmission occasion, and a second TCI state of the two TCI states pointed to by the lowest codepoint among the at least one codepoint pointing to two TCI states is applied to the second PDSCH transmission occasion, and a TCI mapping pattern for CycMapping applies to remaining PDSCH transmission occasions.

19. The base unit of claim 16, wherein, when a value indicated by RepNumR16 in PDSCH-TimeDomainResourceAllocation is equal to or larger than three and SeqMapping is enabled, if the scheduling offset between the reception of the DCI and a first PDSCH occasion is less than a threshold timeDurationForQCL, and the scheduling offset between the reception of the DCI and a third PDSCH occasion is equal to or greater than the threshold timeDurationForQCL, a first TCI state of the two TCI states pointed to by a lowest codepoint among the at least one codepoint pointing to two TCI states is applied to the first and a second PDSCH transmission occasions, and a second indicated TCI state by a TCI field in the DCI is applied to the third and a fourth PDSCH transmission occasions, and a TCI mapping pattern for SeqMapping applies to remaining PDSCH transmission occasions.

20. The base unit of claim 16, wherein, when a value indicated by RepNumR16 in PDSCH-TimeDomainResourceAllocation is equal to or larger than three and SeqMapping is enabled, if the scheduling offset between the reception of the DCI and a third PDSCH occasion is less than a threshold timeDurationForQCL, a first TCI state of the two TCI states pointed to by a lowest codepoint among the at least one codepoint pointing to two TCI states is applied to the first and a second PDSCH transmission occasions, and a second TCI state of the two TCI states pointed to by the lowest codepoint among the at least one codepoint pointing to two TCI states is applied to the third and a fourth PDSCH transmission occasions, and a TCI mapping pattern for SeqMapping applies to remaining PDSCH transmission occasions.
